(19) United States
(12) Patent Application Publication
(10) Pub. No.: US 2007/0276867 A1
(43) Pub. Date: Nov. 29, 2007

(54) Embedded inspection image archival for electronics assembly machines

(76) Inventors: David Fishbaine, Minnetonka, MN (US); Steven K. Case, St. Louis Park, MN (US)

Correspondence Address: Christopher R. Christenson;WESTMAN, CHAMPLIN & KELLY, P.A., Suite 1400, 900 Second Avenue South, Minneapolis, MN, 55402-3319, US

(21) Appl. No.: 11/439,376

(22) Filed: May 23, 2006

(51) Int. Cl. G06F 17/00

(52) U.S. Cl. 707/104.1; 707/2

(57) ABSTRACT

A pick and place machine includes a vision system for acquiring at least one image relative to at least one component-related operation within the pick and place machine. The at least one image is stored along with one or more trace keys associated with the component-related operation. A database of images and associated trace keys can then be used to analyze operation of the pick and place machine to identify aspects that are out of control, or threaten to be out of control.

### COPYRIGHT RESERVATION

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

Pick and place machines are generally used to manufacture electronic circuit boards. A blank printed circuit board is usually supplied to the pick and place machine, which then picks electronic components from component feeders, and places such components upon the board. The components are held upon the board temporarily by solder paste, or adhesive until a subsequent step in which the solder paste is melted, or the adhesive is fully cured.

Pick and place machine operation is challenging. Since machine speed corresponds with throughput, the faster the pick and place machine runs, the less costly the manufactured board. Additionally, placement accuracy is extremely important. Many electrical components, such as chip capacitors and chip resistors are relatively small and must be accurately placed on equally small placement locations. Other components, while larger, have a significant number of leads or conductors that are spaced from one another at a relatively fine pitch. Such components must also be accurately placed to ensure that each lead is placed upon the proper pad. Thus, not only must the machine operate extremely fast, but it must also place components extremely accurately.

In order to enhance the quality of board manufacture, fully or partially populated boards are generally inspected after the placement operation(s), both before and after solder reflow, in order to identify components that are improperly placed or missing or any of a variety of errors that may occur. Automatic systems that perform such operation(s) are highly useful in that they help identify component placement problems prior to solder reflow allowing substantially easier rework or identify defective boards after reflow that are candidates for rework. One example of such a system is sold under the trade designation Model KS Flex available from CyberOptics Corporation of Golden Valley, Minn. This system can be used to identify such problems as alignment and rotation errors; missing and flipped components; billboards; tombstones; component defects; incorrect polarity; and wrong components. Identification of errors pre-reflow provides a number of advantages. Rework is easier; closed-loop manufacturing control is facilitated; and less work in-process exists between error generation and remedy. While such systems provide highly useful inspection, they do consume plant floor-space as well as programming time, maintenance efforts and the like.

One relatively recent attempt to provide the benefits of after-placement inspection located within a pick a place machine itself is disclosed in U.S. Pat. No. 6,317,972 to Asai et al. That reference reports a method for mounting electric components where an image of a mounting location is obtained prior to component placement, and compared with an image of the mounting location after component placement to inspect the placement operation at the component level. Although embedded inspection represents an important advance for pick and place machines, there are still many aspects that can be improved.

### SUMMARY OF THE INVENTION

A pick and place machine includes a vision system for acquiring at least one image relative to at least one operation within the pick and place machine. The at least one image is stored along with one or more trace keys associated with the operation. A database of images and associated trace keys can then be used to analyze operation of the pick and place machine.

### BRIEF DESCRIPTION OF THE DRAWINGS

FIG. 1 is a diagrammatic view of a simplified assembly line with which embodiments of the present invention are particularly useful.

FIG. 2 is an exemplary method of generating triggers.

FIG. 3 is a diagrammatic view of a component placement operation with an embedded inspection system in accordance with embodiments of the present invention.

FIG. 4 is a diagrammatic view of a database configured to store images related to component-related operations as well as to store trace keys associated with the images.

FIG. 5 is a chart of Placement Faults versus Feeder ID indicating how analysis of stored trace key information can be used to identify a problem related to machine operation.

### DETAILED DESCRIPTION OF ILLUSTRATIVE EMBODIMENTS

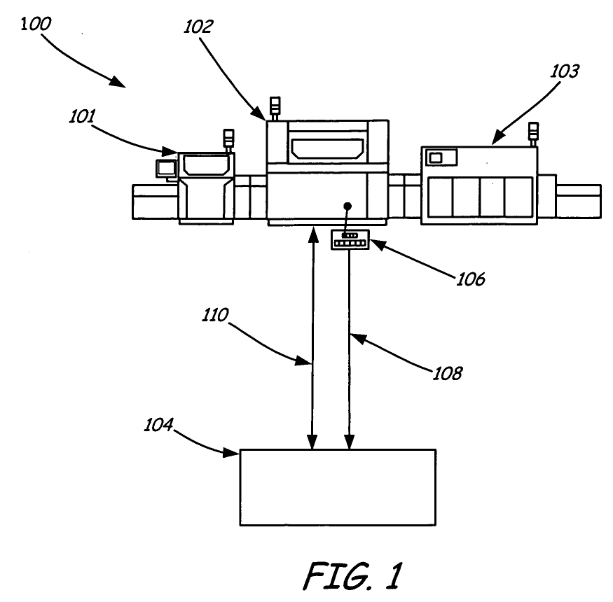

FIG. 1 shows an exemplary simplified Surface Mount Technology (SMT) production line 100 consisting of a solder paste screen printer 101, a single instance of robotic component placement equipment 102, also referred to as a “mounter” or as a “pick and place machine”, and a reflow oven 103.

Mounter 102 has installed, within it, image sensing device or devices 106, deployed to optimally observe various aspects of the mounting process. Preferably, image sensing device(s) 106 are 2-D cameras situated to observe the component pickup and component placement locations and are operated in a way to permit mounter 102 to run at its full rated speed, without needing to slow down to allow image acquisition.

Image sensing device(s) 106 transmit images to a computer 104 along communication channel 108; computer 104 is preferably situated proximate mounter 102. Computer 104 preferably performs image processing, image storage to a database, image recall from a database, and provides a user interface and other suitable functions. Computer 104 can be included with or part of the controller of mounter 102.

Image sensing device(s) 106 receive information from the computer 104 via Sensor Communications channel 108 in support of acquisition of images. Exemplary items received by sensing devices 106 from computer 104 are calibration data, target coordinates for triggering the acquisition of images, firmware updates, illumination and exposure control, et cetera.

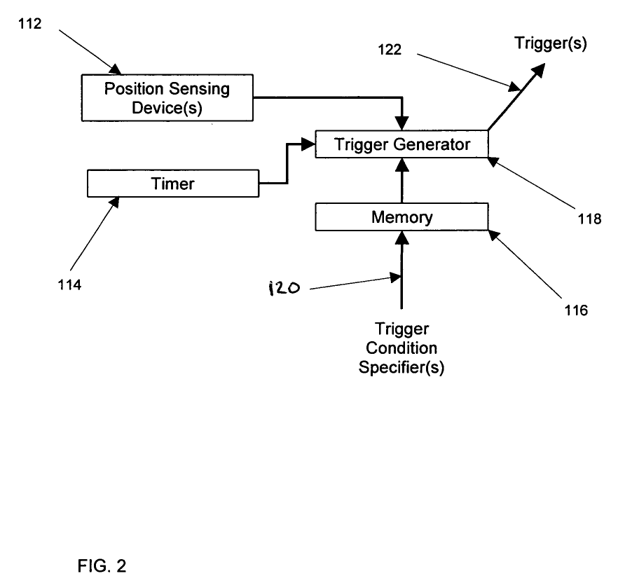

FIG. 2 is illustrates merely one exemplary method of generating triggers. However, embodiments of the present invention can be practiced using any suitable triggering techniques. Referring to FIG. 2, image sensing device(s) 106 can be triggered to acquire image(s) based upon observation of the mounter's position as indicated by position sensing devices 112. Exemplary position sensors include position encoders, rotary or linear, typically used by the controller of mounter 102 to enable it to position the mounter's various axes at or near their target positions. Additional position sensors can be added to mounter 102 for the purpose of providing data upon which triggers can be predicated.

When one or more position sensing devices 112 observe that the relevant mounter position(s), either individually or in aggregate, at the same moment or in a sequence, exactly or within a specified range, or otherwise, match the physical portion of the trigger condition, a condition herein referred to as Physical Trigger is deemed to exist.

Trigger condition specifiers 120 may originate from any computer or combination of computers within the overall apparatus, including the controller of mounter 102 or the computer 104.

Position sensing devices 112 can be located within or without the mounter 102, as long as they are able to observe the desired motions.

The entire trigger generating mechanism of FIG. 2, or portions thereof, may be located within mounter 102 or within the image sensing device(s) 106 or elsewhere, as long as the mechanism is able to access the required inputs and deliver the required outputs.

If the Physical Trigger is the only condition specified for commencing image acquisition, then that acquisition should begin preferably with as little delay as possible, for example, less than one microsecond.

Additional triggering techniques can rely on time, either solely or in combination with position. Some examples include: Image(s) can be acquired continuously; or more usefully, one or more triggers can be generated such that the first one occurs when a Physical Trigger condition exists followed by subsequent triggers generated at specified time delay(s) from the first one. In this fashion, a single image or a burst of images(s) can be acquired at prescribed time delays from a physical event.

Another way to captures images of interest is to acquire images from image sensing devices(s) 106 asynchronously, possibly continuously at high speed, to position changes and select the images that are of interest, based wholly or in part on the image content.

High speed acquisition of images, however triggered, can acquire information about transient events that may be used in analyzing the causes of failures.

Examples of such transient events that can occur at component pickup are component levitation or flipping, both possibly caused by incorrect vacuum timing or possibly undesirable electrostatic forces. Other transient events occur at the component place location.

Embodiments of the present invention are able to acquire bursts of images, for example, a burst of 24 images, with a per-image interval of as short as 10 milliseconds. Thus, for a total period spanning 230 milliseconds, transient events that are visible to the imager over at least 10 milliseconds can be captured.

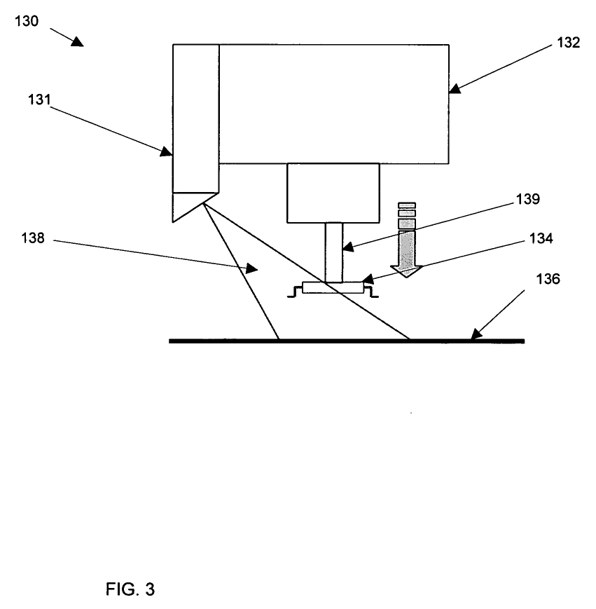

Embodiments of the present invention generally acquire images of important aspects of the mounting process. FIG. 3 is a simplified illustration of a placement “head” 130 that incorporates an embodiment of the present invention.

Placement head 130 is a mechanical structure disposed to move in multiple axes relative to substrate 136, such motion and structure being configured to properly pick up component 134 from a component feeding mechanism (not shown) and mount component 134 onto substrate 136. Substrate 136 is most often a printed circuit board or “PCB.” “PCB” as used herein is intended to refer to a generalized substrate.

Another important aspect of the overall assembly process is the printing of solder paste by a solder paste printer 101. Images of substrate 136 taken prior to component 134 being mounted to substrate 136 can show these solder paste deposits (not shown in FIG. 3).

In the embodiment illustrated in FIG. 3, imager(s) 106 and illuminator(s) are combined into one housing 131 or “sensor” and are preferably arranged to acquire images while placement head 130, a portion of which is illustrated at reference numeral 132 picks up component 134 from a component feeding mechanism (not shown) and then places the component 134 onto PCB 136.

Images of component feeding mechanism (not shown) prior to component 134 pickup show the component in the feeder. Images of component feeding mechanism (not shown) after normal component 134 pickup show an empty location in the feeding mechanism. Acquisition of this last image or possibly of subsequent images can be timed to show the component 134 attached to nozzle 139.

Component placement faults often have, as their fundamental root cause, a component pickup problem, so capturing images at the component pickup location offers significant utility in diagnosing placement faults and, ultimately, correcting their cause.

Images of PCB 136, acquired before placement of component 134, can reveal solder paste. Images acquired after placement can reveal the component mounted to the PCB.

Images of the PCB 136, whatever the intermediate state of assembly, can be acquired by sensor 131, regardless of whether the step of placing a component onto the PCB 136 is imminent. In the case where the placement step is not imminent, imager(s) 106 and illuminator(s) of sensor 131 continue to have a mechanical and optical disposition that is preferably optimal for acquiring images of the PCB. Placement head 130 need not stop motion relative to PCB 136 for these images to be acquired if imager(s) 106 and illuminator(s) are arranged so as to acquire images over short exposure times.

Imager(s) and illuminator(s) need not be combined into a single housing 131, although in some applications, there is little space available for these functions and combining, as illustrated, may be one reason this is preferred. In FIG. 3, the imaging field of view and an idealized front illumination cone are illustrated by reference numeral 138.

Alternative arrangements wherein the imager(s) and illuminator(s) are separated offer the advantage of illumination from other than the front; the resulting images may have fewer shadows, or may have details better illuminated than can be provided by any single direction of illumination or may make better use of emitted light, etc.

Images are preferably acquired rapidly compared to motion of mounter 102, so that each image appears frozen even in the presence of motion and also so that a plurality of images can be acquired during a single assembly step. Using both short exposure times and rapid frame rates makes it possible to capture quality images of fleeting events, such events possibly occurring over a small fraction of the normal time required for any single assembly step. Such images can be very important to understanding why an error occurred.

The exposure time used to acquire each image should preferably be as short as possible, for example, 100 microseconds or less, to allow moving features to appear adequately frozen in the acquired images.

The maximum frame rate should be as fast as possible, to permit images of fleeting events to be captured, for example 1000 frames/second.

The maximum allowable exposure time is inversely related to the maximum relative speed between the imager's imaging field of view 138 and the object to be imaged 134. In the assembly step illustrated in FIG. 3, the relative speeds are limited to about one meter per second and 100 microns of blur is tolerable, resulting in a maximum exposure time of 100 microseconds.

Applications where the relative speed is higher, or the requirement to suppress motion induced blur to less than 100 microns exists, will require a shorter exposure time. The primary challenge posed by such short exposure times relates to light collection on the imager. The short time allowed under these circumstances for light integration on the imager calls for brighter and/or better directed light sources, or optics configured to more efficiently collect whatever light is available, or a spatial rearrangement of the light sources relative to the receive optics so as to allow more of the source light to be collected, or combinations of the above.

The preferred light source includes one or more high brightness LEDs which can straightforwardly be operated to act as strobe illuminators. They have the advantage of compactness, ease of use, are efficient and have long life. Alternative illuminators that may be also be used in very short exposure time applications are gas discharge flash lamps, which have the advantage of extreme brightness relative to LEDs, however they are not as compact and are more difficult to use.

A preferred imager is a CMOS area array such as those supplied by Micron Technology, Inc. Devices are available that can run at 500 frames per second rates. Furthermore, subsets of the entire frame can be read out at increasingly fast rates if only a portion of the entire frame is required. Only half of the pixels in a frame are required for the application shown in FIG. 3. Thus, in this case, 1000 images per second can be achieved.

Referring to FIGS. 1 and 3, exemplary information sent by computer 104 to mounter 102 through mounter communications channel 110 includes results from image processing algorithms running within computer 104 on images sent to computer 104 by image sensing devices 106.

Such image processing results include detected faults in the assembly process, created by mounter 102 or not, detectable by said image processing algorithms. Additional image processing results include measured parametric results, such as a component's position on the PCB.

One example of such a detected fault is when a component is missing, when it would nominally be present on the PCB after placement should have occurred. Another example of a detected fault is when a component is incorrectly positioned on the PCB, as compared to the nominal position, after placement occurred. Another example of a detected fault is when a component has not been picked, as evidenced by the component not being detected on the nozzle, or by it continuing to be present in the feeder mechanism after pickup should have occurred. Another example of a detected fault is when a component is incorrectly picked, as compared to the appearance of a nominally picked component.

“Component incorrectly positioned” means excessive rotation about any of the three degrees of freedom of rotation, excessive translation along any of the three degrees of freedom of translation or any combination thereof. Still another example of a detected fault is when solder paste is missing, when it would nominally be present. “Solder paste missing” means a less than nominal amount of solder paste is present on the PCB as compared to a possibly variable threshold. Component land patterns are comprised of multiple nominally individual solder paste deposits. The determination of “solder paste missing” can be made if any individual solder paste deposit has less paste than a threshold, or if an average of a number of individual paste deposits is less than a possibly different threshold, or if the variation among nominally identical solder paste deposits exceeds a threshold, or if the ratio of solder paste sizes deviates from unity by a threshold, or if several instances of a given component's solder paste deposits fail in sequence, et cetera. Still another example of a detected fault is when solder paste is incorrectly positioned, as compared to the nominal position. “Solder paste incorrectly positioned” means excessive rotation about the Z axis (perpendicular to the plane defined by the PCB), excessive translation along any of the three degrees of freedom of translation or any combination thereof. Still another example of a detected fault is when excess solder paste is present, as compared to the nominal amount. Excess solder paste can result in a fault wherein an unintended electrical contact, known as a short, is created. Other faults are detectable as well, as will be readily apparent to those skilled in the art of inspection of PCBs.

At least a portion of the information flowing through mounter communications channel 110 from mounter 102 to computer 104 is related to the images acquired by image sensor(s) 106. This information is preferably saved into a database in a way that associates it with the images acquired by image sensor(s) 106, which images are also preferably saved into the database.

Exemplary information sent by the mounter 102 to computer 104 through mounter communications channel 110 includes: data about what raw materials are being used by the mounter 102 in its assembly process; data about what physical subsystems (not shown) within the mounter 102 are being used in each step of the assembly process; and data about what physical location on the PCB is the target location of a particular step of the assembly process.

The following detailed and specific example is provided for illustrative purposes. Mounter 102 ID=98h7z informs computer 104 that nozzle 139 ID=2334 is used to pick a component 134 that is an integrated circuit of lot code=987abc supplied by vendor=“vendor name” from component feeder ID=z8s4d (not shown). This component will be placed onto PCB 136 ID=20398y4dsljfb at location x=123343, y=09873434 where the location has the name=“U189.”

The data about raw materials can include unique names of a raw material item, or less specific names for groups of raw materials or any other information that could be used to track or diagnose a fault in the assembly.

An example of a unique name of a raw material item is a unique identifier attached to PCB 136 and allows the particular PCB 136 to be uniquely identified among other processed PCBs 136. Preferably this unique identifier is in the form of an RFID tag or a barcode. This unique identifier allows the PCB to be tracked unambiguously through the assembly, test and shipping processes. The unique identifier would preferably be machine readable and human readable. Furthermore, after shipment, this unique identifier may remain attached, either physically or logically, directly or by inference or otherwise, to the final assembled product while it is in use in the field. An example of a non-unique identifier for a raw material item is a lot or date code or a sequence number.

Additional sources of useful information, besides mounter 102, can provide data that can archived to the database 144 and associated with the captured image(s) to which they apply. Examples of these are CAD/CAM databases (not shown) located proximate or remote from mounter 102, sensors that could be deployed near to mounter 102 or to the computer 104 such as temperature or ambient light sensors, or a computer readable clock providing the date and time, et cetera. Another source of information is an operator ID as entered via a user interface through a security card reader, for example. Yet another source of relevant data is an image processing algorithm implemented within computer 104, which can result in a signal indicating a fault condition, a no fault condition, or a numeric measurement of some parameter of interest. An example of such a numeric parameter is the position of the component 134 relative to some feature on the PCB 136. Information from other suitable sources may used as well. The above examples are provided for illustration and are not meant to be an exhaustive listing of all information.

Information as described above, whether sent by mounter 102 to computer 104 through mounter communications channel 110 or acquired directly or indirectly from additional sources, or generated by image processing algorithms, et cetera will in aggregate be referred to as Trace Keys.

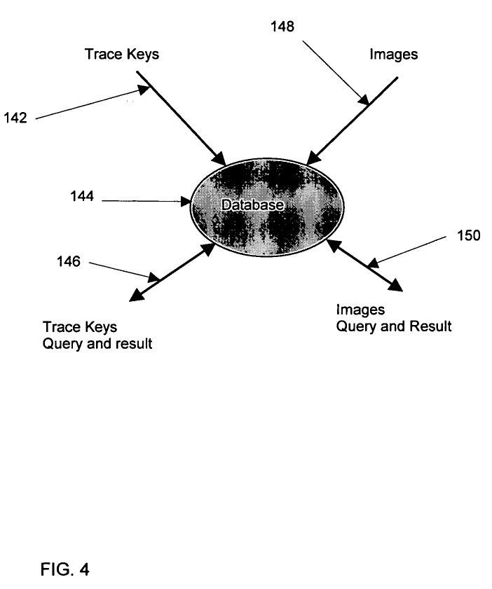

Trace Keys, coupled with the images acquired by image sensing device(s) 106, have a variety of valuable uses. If a defect is found while a PCB is being built, or anytime thereafter, it is possible to use Trace Keys and the database 144 of FIG. 4 to recall images acquired while that exact PCB was being built. Those images, taken during individual assembly steps, can be used to help understand why the failure occurred. Conversely, those recalled images can also be used to exonerate specific assembly steps as the cause of the failure. Both outcomes are useful.

The diagnosis of cause of a detected failure on a PCB is referred to herein as root cause failure analysis, or RCFA. Trace Keys play a critical role in the performance of RCFA in accordance with embodiments of the present invention because they allow relevant information, comprised of images or other Trace Keys, to be fetched with a reduced chance of also fetching irrelevant information.

RCFA can be performed in the factory that is assembling the PCB. This is especially useful if an error is detected and the RCFA is conducted before the assembly ships. The first permits the error to be repaired while it is still in the factory. The second permits a timely understanding of why the error occurred, thereby facilitating process improvements that should reduce the probability of future error creation.

Also, RCFA can be performed later, if the assembly fails at later inspection steps or while in the field. Examples are provided below.

The use of Trace Keys and the associated images is not limited to RCFA. For example, mounter performance can be measured, such performance metrics can be related to quality, throughput, reliability, et cetera. For instance, if a mounter is to place a difficult-to-place component onto a PCB, images of the placement of that component can be used to determine that it is placed correctly. The time stamp Trace Key can be used to determine how quickly the mounter is placing components. The fraction of time an operation fails to properly complete can be used to determine the reliability.

A use for this collection of examples is mounter qualification, or acceptance testing. Mounter vendors provide specification data sheets for their products. Before they ship the mounter, they can perform an outgoing quality test facilitated by embodiments of the present invention.

Additionally, end-users possibly as part of a quality process, or possibly as part of an incoming acceptance test, can confirm that a mounter is meeting its performance specifications. Further, if the mounter fails to meet a performance specification, embodiments of the present invention can be used to help diagnose the underlying reason.

Another use is for statistical process control or SPC. If the mounter is generating excessive faults on a particular assembly step, as indicated by the Trace Keys and as detected by embodiments of the present invention, then the mounter can be signaled via communications channel 110 and respond accordingly.

Also, even if the mounter is not generating faults, but is trending, as observed in accordance with embodiments of the present invention, in a way that would likely eventually generate faults, then that condition can also be signaled to the mounter via communications channel 110 so that the mounter can react accordingly.

SPC comprises a variety of alarm conditions that are helpful in generating quality assemblies; the above are simple examples thereof.

These last examples are not RCFA because they are not intended to find the cause of a problem on an assembled PCB, but are instead targeted toward understanding the performance of the mounter, allowing timely reaction to detected faults, or reacting so as to prevent likely faults.

Yet additional uses for Trace Keys will become apparent below.

Referring to FIG. 4, images 148 and Trace Keys 142 arrive at database 144 from sources as described above. Database 144 is arranged to associate one or more Trace Keys with one or more images so that searches can be constructed in any one of the four following ways.
A. One or more Trace Keys 146 are specified in a query and Image(s) 150 are the search result.
B. One or more Trace Keys 146 are specified in a query and one or more Trace Keys 146 are the search result.
C. An image 150 or a portion thereof is specified in a query and image(s) 150 are the search result.
D. An image 150 or a portion thereof is specified in a query and one or more Trace Keys 146 are the search result.

In situation (A), Trace Key(s) are used to query the database. The user, which can be a human or an algorithm, is interested in fetching images associated with those Trace Key(s). An example of this case is where a human is conducting RCFA. In the case where said PCB has a unique ID, the human can use this unique ID to query the database for all images acquired while that particular PCB was being built. This will likely result in too many images to be of use; many images of that PCB will not be relevant to diagnosing the root cause of the defect.

The user can limit the result size by adding information, in the form of additional Trace Keys, to the search. Example additional Trace Key data might be the component target name, often referred to as a Reference Designator. Or, the user could specify the component package size, et cetera. In this way, the human generating the query can supply as many Trace Keys as is necessary to limit the results to what is interesting.

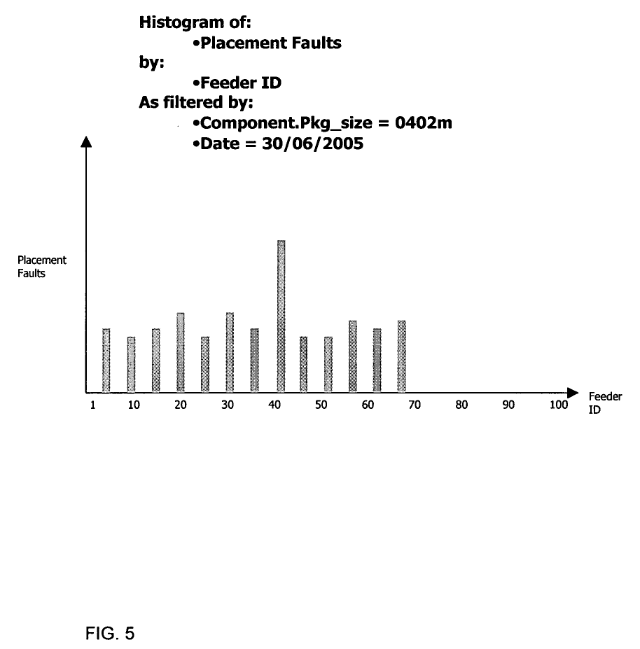

Situation (B) is where Trace Key(s) are also used to query the database, but here the user is interested in fetching other related Trace Key(s). An example of this case is shown in FIG. 5 where the user has generated a histogram chart of placement failures (as detected by image processing algorithms and therefore also a Trace Key). The data used to construct the chart are other Trace Keys, to wit: the Feeder ID (shown on the X axis) when those feeders were being used to deliver components of a certain package size (when the Trace Key called Pkg_size is equal to “0402m”) and when the date was Jun. 30, 2005.

The utility of this sort of query is evident; one feeder is contributing to errors substantially more than the others, at least when it was delivering the specified part on the specified date. Additional queries of this type could be used to learn if this feeder is more broadly a problem or otherwise.

Situation (C) is where an image or portion thereof is used to query the database and images are the desired result. This query could be used as follows: The user selects a certain specific region of an image that contains something of interest. The user then asks the database to recall other images that look similar to the selected region. For example, if an image contains indications of a process problem, without having to characterize the problem parametrically, the user can search for other similar occurrences.

Situation (D) is where an image or portion thereof is used to query the database and Trace Keys are the desired result. In the above Situation (C) the user is searching for other images that appear similar. Here, the user is searching for Trace Keys attached to the similar images. A use for this become clear: If the search result yields Trace Keys that, for example, show that the apparent defect is associated with a particular raw material or mechanical means within the mounter, then a cause of the defect can be inferred. A chart similar to the one shown in FIG. 5 can be generated, where the Y axis is replaced by “Occurrences of Similar Appearance”.

Either situation (A) or situation (C) can be used to fetch a plurality of still images from the database. In some circumstances, these images may be assembled into animations. Animations are very informative to humans because the human eye is drawn to movement. As an example, the user makes a Trace Key based query (according to Situation (A)) resulting in a plurality of images, whose image content is nominally identical. These images, for example, could be of a particular part after it is mounted to a particular location on a plurality of PCBs. If all the raw materials plus the process of building the PCB up until the point where the images were acquired were all perfectly repeatable, then all of these images would look perfectly the same. In reality, these images will be different from one another because the processes are all not perfectly repeatable. An animation comprised of a sequence of these individual images, for example, thirty images played back at a rate of, for example, ten images per second, will play over three seconds and will cause the eye to be drawn to apparent movement. Larger apparent movement is caused by poorer repeatability.

It is important, when constructing animations, to suppress apparent image movement caused by variations in the way images are acquired, leaving to the greatest extent possible only that apparent movement indicative of process irrepeatability. For example, if images are acquired at slightly different mechanical positions from one another, the resulting image shifts should be suppressed before the animation can be used as described above. Suppression of image shifts can be accomplished in various ways.

If data from an independent means of measuring the shift, such as an encoder, is available, then one or more of the images can be translated an amount to accommodate this measured shift prior to assembly into the animation. Alternatively, the image content itself can be used to learn the required shift through image processing algorithms, for example, normalized correlation.

The entire image can be used to construct the correlation kernel, or an optimized subset can be used. A-priori information about what sections of the image should be stable can be used to affect the selection of this optimized subset.

Additional image corrections that can enhance the usefulness of animations relate to imager corrections. For example, if multiple independent imagers and illumination systems are used to acquire images of nominally identical assembly steps, then corrections relating to differences in those systems would be preferable. Examples of such corrections are color, offsets (sometimes called fixed pattern noise), photosensitivity (or pixel gain), orientation (caused by mechanical variations in the system), illumination variation (in aggregate and spatially), etc. Suppressing these errors prior to assembling individual images into animations again has the benefit of reducing apparent movement unrelated to process variation.

Clearly, there will be a large amount of images and data acquired and stored in the database. It is desirable to save the acquired images and data for lengthy periods of time, especially to support RCFA of field failures. There are various ways to do this. One way is to add disk storage. Another way is to extend the total available storage with a tape or optical storage device or other mass storage archival means. Yet another way is to compress the images.

Algorithms such as JPEG compression permit compression ratios of 10:1 or more without severe degradation in image appearance. JPEG compression, for example, can be economically performed in electronic hardware, possibly situated proximate the image sensing devices (106). Alternatively, the compression algorithm can be implemented in software running on the computer (104). In either case, the total quantity of stored images can be substantially increased at the cost of some degradation of image quality.

FIG. 1 is a schematic drawing of a simplified assembly line 100 having only one mounter 102. Most assembly lines are more complex, having a plurality of mounters. If each mounter in an assembly is equipped with image sensors 106 and computers 104 as illustrated in FIG. 1, then images and Trace Keys of all, or nearly all, assembly steps performed by all mounters on that assembly line will be recorded to each database implemented upon computer readable media locally on computer 104.

It is preferable for all of the computers 104 in this more complex assembly line to be networked together with one another and to other locations so as to allow them to cooperate in database searches. In this fashion, a person situated near to or remote from the assembly line can make a database query according to Situations (A-D) and view the results.

Cooperative database searches are preferred also because as more and more mounters are equipped with embedded inspection in accordance with embodiments of the present invention and therefore more and more databases are operational, a proportional number of computers are added. Thus, the computing power and disk storage available to perform database searches scales along with the amount of data that might be searched. In contrast, if a centralized database server were used, for example, to save all data originating from a single assembly line with an increasing number of mounters, the computing and storage performance requirements on that single server would increase while the computing power and disk performance would be constant.

Of course it is possible to scale up the performance of this central server to some extent, but the range and cost of this scalability is not nearly as much as can be achieved through the cooperative approach.

Cooperative databases as referred to herein are sometimes called distributed or federated databases. They are well known in the database industry and envision exactly what has been described immediately above, wherein multiple loosely connected computers cooperate in searching for data, each searching its own local portion of a distributed database.

Accordingly, one Trace Key should be a unique mounter identifier. This mounter identifier identifies a single specific mounter, allowing, for example, a query to select images or other Trace Keys generated by that mounter.

Furthermore, many manufacturing facilities have more than one assembly line. Two or more assembly lines can be allocated to building a single product when a single assembly line cannot meet production requirements. Therefore a database search initiated, for example, in support of RCFA using Situation (A) that specifies a particular defect location on a unique PCB, will preferentially involve all computers 104 in a given facility. In this fashion, the query need not specify a given mounter or even a given assembly line. All mounters that might have participated in manufacturing the specified PCB will conduct searches on their local databases for the specified Trace Keys and deliver the associated images and Trace Keys.

The usefulness of another Trace Key is now evident: A unique assembly line identifier that identifies, directly or indirectly, what unique mounters are deployed together in a single line. This information will allow the user in the above example to learn, if the user is interested, which assembly line built the PCB.

Extending the concept even further, some companies have multiple facilities sometimes scattered throughout the world. Networking all of these facilities together can permit a person, say at the company headquarters where perhaps no assembly takes place, to view images and Trace Keys acquired anywhere that company builds PCBs. The usefulness of yet another Trace Key is now evident: A unique facility identifier that identifies, directly or indirectly, what unique assembly lines are deployed in a single facility.

Finally, some companies do not build their own PCBs at all. They contract to sometimes large assembly specialist companies to build PCBs for them. Sometimes, they contract to more than one such supplier to build a given product. The usefulness of yet another Trace Key is now evident: A unique assembly supplier identifier that identifies, directly or indirectly, what vendor built the PCB.

All of the above permits a person from the primary company (that in the above example, does not make PCBs) to be able to initiate a database query to all suppliers, possibly spanning multiple companies that are geographically disparate, each possibly spanning multiple facilities, each possibly comprised of multiple assembly lines, each possibly comprised of multiple mounters, at least some of which are equipped with the present invention.

One practical use for this sort of query allows the customer of PCB manufacturers to audit their supplier(s). Another use is to facilitate RCFA on a field return. Typically, PCB manufacturers do not participate in RCFA of field returns. Their focus is on quality prior to when the PCB ships to their customer.

However, the primary company often implements incoming inspection and usually has a customer service department that repairs or diagnoses field failures. Interestingly, this organization typically has little to no access to detailed manufacturing data from their suppliers. Thus, embodiments of the present invention can help bridge this information gap.

Not all Trace Keys need be or are optimally associated directly with the images in the possibly distributed database in accordance with embodiments of the present invention. Secondary databases can be used to associate, for example, the assembly line identifier with specific mounters that comprise that line.

There are many algorithms that could be gainfully applied to images acquired by the present invention.

Image processing has, so far, been used to refer to the extraction of summary information from images in Real Time; that is substantially keeping up with image acquisition. In this fashion, said summary information can be added as Trace Keys to the data base 144 substantially concurrently with image addition to that database.

Additionally, some image processing algorithms are preferably executed when a mounter operating in accordance with embodiments of the present invention is not acquiring new images, that is, not in Real Time.

An example of such an algorithm is JPEG compression that, as mentioned above, allows more images to reside on a computer disc of given size. This compression step, which can consume significant CPU resource, need not run in Real Time as long as some “idle” time is available for this function before the disc would otherwise fill up.

Another example is the animation technique described above and used by a human to quickly review a series of images that should nominally be identical. As previously discussed, the generation of such an animation requires possibly numerous, and possibly CPU intensive, image correction steps.

Additionally, once a human confirms that each image in the animation is of a good assembly, it is relatively straightforward to use those individual images to train a Statistical Appearance Model (SAM). Statistical Appearance modeling is known. Once the SAM model is trained, it can be applied to images acquired from assemblies of unknown quality and thereby used to detect defects in Real Time.

Image compression, the generation of the animation and the steps of training a system to recognize good from bad are examples of algorithms that are preferably done while the mounter is “idle” or, alternatively, by a computer with access to database 144 and without the Real Time obligations of computer 104.

Although the present invention has been described with reference to preferred embodiments, workers skilled in the art will recognize that changes may be made in form and detail without departing from the spirit and scope of the invention.

What is claimed is:

1. A method of acquiring and storing information related to pick and place machine operation, the method comprising:
acquiring an image within the pick and place machine;
obtaining at least one Trace Key related to the image;
storing the image;
storing the at least one Trace Key; and
associating the at least one Trace Key to the image.

2. The method of claim 1, wherein the image is related to a pick operation of a component.

3. The method of claim 1, wherein the image is related to a placement operation of a component.

4. The method of claim 1, wherein the image and the at least one Trace Key are stored in a database.

5. The method of claim 4, wherein the database is a distributed database.

6. The method of claim 1, wherein the at least one Trace Key includes information about the pick and place machine.

7. The method of claim 6, wherein the Trace Key is obtained from the pick and place machine.

8. The method of claim 1, wherein the at least one Trace Key includes information about a component.

9. The method of claim 8, wherein the Trace Key is obtained from the pick and place machine.

10. The method of claim 1, wherein the at least one Trace Key includes information about a substrate.

11. The method of claim 10, wherein the at least one Trace Key is obtained from the pick and place machine.

12. The method of claim 1, wherein the at least one Trace Key includes information about an environmental variable present when the image was acquired.

13. The method of claim 12, wherein the at least one Trace Key is obtained from at least one sensor.

14. The method of claim 12, wherein the at least one Trace Key is obtained from the pick and place machine.

15. A method of evaluating operation of a pick and place machine, the method comprising:
acquiring and storing at least one image relative to a component pick operation within the pick and place machine;
acquiring and storing at least one image relative to a component placement operation within the pick and place machine;
recalling the stored images and generating at least one performance metric based upon the recalled images; and
using the at least one performance metric to establish the process capability.

16. The method of claim 15, and further comprising storing at least one Trace Key related to at least one image.

17. The method of claim 15, wherein the image and the at least one Trace Key are stored in a database.

18. The method of claim 17, wherein the database is a distributed database.

19. The method of claim 16, wherein the at least one Trace Key includes information about the pick and place machine.

20. The method of claim 19, wherein the at least one Trace Key is obtained from the pick and place machine.

21. The method of claim 16, wherein the at least one Trace Key includes information about a component.

22. The method of claim 21, wherein the at least one Trace Key is obtained from the pick and place machine.

23. The method of claim 16, wherein the at least one Trace Key includes information about a substrate.

24. The method of claim 23, wherein the at least one Trace Key is obtained from the pick and place machine.

25. The method of claim 16, wherein the at least one Trace Key includes information about an environmental variable present when the image was acquired.

26. The method of claim 25, wherein the at least one Trace Key is obtained from at least one sensor.

27. The method of claim 25, wherein the at least one Trace Key is obtained from the pick and place machine.

28. A computer readable medium having data stored thereon, the data comprising:
an image acquired within a pick and place machine;
at least one Trace Key related to the image; and
an association between the image and the at least one Trace Key.

29. The computer readable medium of claim 28, wherein the image is related to a pick operation of a component.

30. The computer readable medium of claim 28, wherein the image is related to a placement operation of a component.

31. The computer readable medium of claim 28, wherein the at least one Trace Key includes information about the pick and place machine.

32. The computer readable medium of claim 28, wherein the at least one Trace Key includes information about a component.

33. The computer readable medium of claim 28, wherein the at least one Trace Key includes information about a substrate.

34. The computer readable medium of claim 28, wherein the at least one Trace Key includes information about an environmental variable present when the image was acquired.

35. A method of evaluating operation of a pick and place machine, the method comprising:
acquiring and at least one image relative to an operation within the pick and place machine;
processing the at least one image to generate at least one performance metric; and
storing the at least one image and the at least one performance metric; and
associating the at least one performance metric with the at least one image.
